(19) United States
(12) Patent Application Publication
(10) Pub. No.: US 2014/0051312 A1
(43) Pub. Date: Feb. 20, 2014

(54) RUBBER COMPOSITE REINFORCED WITH A TEXTILE MATERIAL PROVIDED WITH A THERMOPLASTIC ADHESIVE

(71) Applicants: Vincent Abad, Domicile (FR); Sébastien Rigo, Domicile (FR); Emmanuel Custodero, Domicile (FR)

(72) Inventors: Vincent Abad, Domicile (FR); Sébastien Rigo, Domicile (FR); Emmanuel Custodero, Domicile (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 13/981,677

(22) PCT Filed: Jan. 31, 2012
(86) PCT No.: PCT/EP2012/051515

§ 371 Date: Oct. 29, 2013

(30) Foreign Application Priority Data
Feb. 3, 2011 (FR) 1150856

(51) Int. Cl. B32B 27/04; B29D 30/06; C09J 7/04

(52) U.S. Cl. CPC B60C 9/0057; B29D 30/0601; C09J 7/041
USPC 442/149; 156/307.3

(57) ABSTRACT

Rubber composite, and in particular tyre, reinforced with a sized textile material, such as a fibre or a film, at least one portion of which is coated with an adhesive layer, capable of adhering directly via curing (crosslinking) to an unsaturated rubber matrix, such as a natural rubber matrix, characterized in that said layer comprises an adhesive composition or thermoplastic adhesive, in the liquid or solid state, which is based on at least one unsaturated thermoplastic styrene (TPS) elastomer and a poly(p-phenylene ether) (PPE).

Such an adhesive based on unsaturated TPS and PPE advantageously makes it possible to replace a conventional textile adhesive of RFL type. Use of such an adhesive for the adhesive bonding of a textile material to an unsaturated, in particular diene, rubber. Process for obtaining such a composite.

### FIELD OF THE INVENTION

The field of the present invention is that of rubber composites, textile materials and adhesive compositions or “adhesives” intended to make such textile materials adhere to unsaturated rubber matrices such as those commonly used in rubber finished articles or semi-finished products.

The present invention relates more particularly to rubber composites reinforced with textile materials sized with adhesive layers based on thermoplastic polymers, especially to sized textile materials capable of reinforcing tyre structures.

### PRIOR ART

It has been known for a very long time to make textile materials such as textile fibres or cords, for example made of polyamide or of polyester, adhere to unsaturated rubber matrices such as diene rubber matrices, using textile adhesives known as RFL (resorcinol-formaldehyde-latex) adhesives comprising at least one diene elastomer latex, such as a natural rubber latex, and a thermosetting phenolic resin.

These adhesives have the known drawback of containing, as base substances, formaldehyde (or methanal) and also resorcinol which it is desirable long-term to eliminate from adhesive compositions because of the recent changes in European regulations regarding products of this type.

Thus, the designers of rubber articles and composites, in particular tyre manufacturers, presently have the objective of finding novel adhesive systems or novel composites reinforced with textile materials that make it possible to overcome the aforementioned drawback.

### BRIEF DESCRIPTION OF THE INVENTION

However, during their research, the Applicant companies have discovered a novel rubber composite reinforced with a textile material provided with a specific adhesive coating of thermoplastic type, which makes it possible to meet the above objective.

Consequently, a first subject of the invention relates to a rubber composite reinforced with a textile material, at least one portion of which is coated with an adhesive layer, characterized in that said layer comprises an adhesive composition which is based on at least one unsaturated thermoplastic styrene elastomer and a poly(p-phenylene ether).

It has unexpectedly been observed that this specific adhesive layer made it possible to ensure a direct and effective adhesion of the textile material to an unsaturated rubber matrix or composition such as those commonly used in tyres.

The invention relates to any rubber composite (finished article or semi-finished product), before and after curing (for final crosslinking or vulcanization), in particular any tyre.

Among the tyres of the invention, mention will especially be made of those intended to be fitted onto motor vehicles of the passenger type, SUVs (“Sport Utility Vehicles”), two-wheel vehicles (especially bicycles and motorcycles), aircraft, or industrial vehicles chosen from vans, “heavy” vehicles—i.e. underground trains, buses, heavy road transport vehicles (lorries, tractors, trailers), off-road vehicles, such as agricultural or civil engineering machines - and other transport or handling vehicles.

The invention also relates to the use, for the adhesive bonding of a textile material to an unsaturated rubber, of an adhesive composition as defined above.

The invention also relates to a process for manufacturing a composite according to the invention, said process comprising at least the following steps:
combining at least one portion of a starting textile material as defined above, the adhesive composition being in the solid state, with a crosslinkable rubber composition, in order to form a rubber composite reinforced with the textile material;
crosslinking the composite thus formed by curing.

The invention and its advantages will be readily understood in light of the description and exemplary embodiments which follow, and also in light of the sole figure relating to these examples which schematically shows, in radial section, a tyre having a radial carcass reinforcement, in accordance with the invention, incorporating a composite and textile material according to the invention.

### DETAILED DESCRIPTION OF THE INVENTION

In the present description, unless expressly indicated otherwise, all the percentages (%) shown are % by weight.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The textile material of the composite of the invention is capable of adhering directly via curing (crosslinking) to an unsaturated rubber (i.e. as a reminder, containing ethylenically unsaturated groups) matrix, that is to say that it is sized or coated at least partially with an adhesive layer comprising at least one adhesive composition, in the liquid or solid state, which is based on at least one unsaturated thermoplastic styrene elastomer and a poly(p-phenylene ether), constituents which will be described in detail below.

The expression “composition based on” should of course be understood to mean a composition comprising the mixture and/or the in situ reaction product of the various base constituents used for this composition, it being possible for some of them to be intended to react or capable of reacting with one another or with their immediate chemical surroundings, at least partly, during the various phases of manufacture of the textile material, of the composites or finished articles comprising such composites, in particular during the final curing step.

It will firstly be recalled that thermoplastic styrene (abbreviated to TPS) elastomers are thermoplastic elastomers in the form of styrene-based block copolymers. Their glass transition temperature (Tg) is preferably negative, more preferably below −20° C., in particular below −30° C.

These thermoplastic elastomers, having an intermediate structure between thermoplastic polymers and elastomers, are made up, as is known, from polystyrene hard sequences linked by elastomer soft sequences, for example polybutadiene, polyisoprene or poly(ethylene/butylene) sequences. This is why, as is known, TPS copolymers are generally characterized by the presence of two glass transition peaks, the first (lowest, preferably negative temperature) peak relating to the elastomer sequence of the TPS copolymer and the second (highest, positive temperature, typically at around 80° C. or more) peak relating to the thermoplastic part (styrene blocks) of the TPS copolymer.

These TPS elastomers are often triblock elastomers with two hard segments linked by a soft segment. The hard and soft segments may be arranged in a linear fashion, or in a star or branched configuration. These TPS elastomers may also be diblock elastomers with a single hard segment linked to a soft segment. Typically, each of these segments or blocks contains a minimum of more than 5, generally more than 10, base units (for example styrene units and isoprene units in the case of a styrene/isoprene/styrene block copolymer or styrene units and butadiene units in the case of a styrene/butadiene/styrene block copolymer). Of course, in that respect they must not be confused with statistical diene copolymer elastomers such as, for example, SIR rubbers (styrene-isoprene copolymers) or SBR rubbers (styrene-butadiene copolymers) which, as is well known, do not have any thermoplastic character.

As a reminder, an essential feature of the TPS elastomer used within the context of the present invention is the fact that it is unsaturated. The expression “unsaturated TPS elastomer” is understood by definition, and as is well known, to mean a TPS elastomer that contains ethylenically unsaturated groups, i.e. it contains carbon-carbon double bonds (whether conjugated or not). Conversely, a saturated TPS elastomer is of course a TPS elastomer that contains no such double bonds.

Preferably, the unsaturated elastomer is a copolymer containing, as base units, styrene (i.e. polystyrene) blocks and diene (i.e. polydiene) blocks, especially isoprene (polyisoprene) or butadiene (polybutadiene) blocks.

Such a TPS elastomer is selected in particular from the group consisting of styrene/butadiene (SB), styrene/isoprene (SI), styrene/butadiene/butylene (SBB), styrene/butadiene/isoprene (SBI), styrene/butadiene/styrene (SBS), styrene/butadiene/butylene/styrene (SBBS), styrene/isoprene/styrene (SIS), styrene/butadiene/isoprene/styrene (SBIS) block copolymers and blends of these copolymers.

More preferably, this unsaturated elastomer is a copolymer of the triblock type, selected from the group consisting of styrene/butadiene/styrene (SBS), styrene/butadiene/butylene/ styrene (SBBS), styrene/isoprene/styrene (SIS), styrene/butadiene/isoprene/styrene (SBIS) block copolymers and blends of these copolymers; more particularly, it is an SBS or SIS, especially an SBS.

According to another preferred embodiment, the styrene content in the unsaturated TPS elastomer is between 10% and 60% by weight. Below 10% there is a risk of more difficult processing of the adhesive due to a thermoplastic nature which decreases, whereas above 60% the adhesion of the textile material to the unsaturated rubber (e.g. diene elastomer such as natural rubber) for which the textile material is intended could be adversely affected. For all these reasons, the styrene content is more preferably in a range from 15% to 55% by weight.

The number-average molecular weight (denoted by Mn) of the TPS elastomer is preferably between 5000 and 500,000 g/mol, more preferably between 7000 and 450,000 g/mol.

Unsaturated TPS elastomers such as for example SB, SBS, SBBS, SIS or SBIS are well known and are commercially available, for example from Kraton under the name “Kraton D” (e.g. products D1116, D1118, D1155, D1161, D1163 for examples of SB, SIS and SBS elastomers), from Dynasol under the name “Calprene” (e.g. products C405, C411, C412 for examples of SBS elastomers) or else from Asahi under the name “Tuftec” (e.g. product P1500 for an example of an SBBS elastomer).

According to one particularly preferred embodiment, the unsaturated TPS elastomer used within the context of the present invention is a functionalized TPS elastomer bearing functional groups selected from epoxide, carboxyl and acid anhydride or ester functions or groups.

More preferably still, this unsaturated TPS elastomer is an epoxidized elastomer, i.e. an elastomer bearing one or more epoxide groups. Epoxidized unsaturated TPS elastomers, such as for example SBS, are known and commercially available, for example from the company Daicel under the name “Epofriend”.

The adhesive composition has another essential feature of comprising, in combination with the TPS elastomer described above, at least one poly(p-phenylene ether) (or poly(1,4-phenylene ether)) polymer (denoted by the abbreviation PPE).

PPE thermoplastic polymers are well known to a person skilled in the art, they are resins that are solid at ambient temperature (20° C.). Preferably, the PPE used here has a glass transition temperature which is above 150° C., more preferably above 180° C. As regards its number-average molecular weight (Mn), it is preferably between 5000 and 100,000 g/mol.

As non-limiting examples of PPE polymers that can be used in the composite of the invention, mention may especially be made of those selected from the group consisting of poly(2,6-dimethyl-1,4-phenylene ether), poly(2,6-dimethyl-co-2,3,6-trimethyl-1,4-phenylene ether), poly(2,3,6-trimethyl-1,4-phenylene ether), poly(2,6-diethyl-1,4-phenylene ether), poly(2-methyl-6-ethyl-1,4-phenylene ether), poly(2-methyl-6-propyl-1,4-phenylene ether), poly(2,6-dipropyl-1,4-phenylene ether), poly(2-ethyl-6-propyl-1,4-phenylene ether), poly(2,6-dilauryl-1,4-phenylene ether), poly(2,6-diphenyl-1,4-phenylene ether), poly(2,6-dimethoxy-1,4-phenylene ether), poly(1,6-diethoxy-1,4-phenylene ether), poly(2-methoxy-6-ethoxy-1,4-phenylene ether), poly(2-ethyl-6-stearyloxy-1,4-phenylene ether), poly(2,6-dichloro-1,4-phenylene ether), poly(2-methyl-6-phenyl-1,4-phenylene ether), poly(2-ethoxy-1,4-phenylene ether), poly(2-chloro-1,4-phenylene ether), poly(2,6-dibromo-1,4-phenylene ether), poly(3-bromo-2,6-dimethyl-1,4-phenylene ether), their respective copolymers and blends of these homopolymers or copolymers.

According to one particular and preferred embodiment, the PPE used is poly(2,6-dimethyl-1,4-phenylene ether) also sometimes known as polyphenylene oxide (or PPO for short). Such commercially available PPE or PPO polymers are for example the PPE called “Xyron S202” from the company Asahi Kasei or the PPE called “Noryl SA120” from the company Sabic.

A person skilled in the art will know how to adjust the formulation of the adhesive composition in light of the description and exemplary embodiments that follow, as a function of the particular applications targeted.

For optimal effectiveness, it is preferred that the PPE/unsaturated TPS weight ratio be between 0.02 and 2.0, more preferably between 0.05 and 1.2, in particular in a range from 0.1 to 0.6.

According to another preferred embodiment, the amount of PPE polymer is adjusted in such a way that the weight content of PPE is between 0.05 and 5 times, more preferably between 0.1 and 2 times, the weight content of styrene present in the TPS elastomer itself

Below the minima recommended above, the adhesion of the textile material to the rubber may be reduced, whereas above the indicated maxima, there is a risk of embrittling the adhesive layer. For all these reasons, the weight content of PPE is more preferably still between 0.2 and 1.5 times the weight content of styrene in the TPS elastomer. The styrene content of the TPS elastomers is data that is well known, available from the manufacturers, and which can be measured in particular by NMR.

The Tg of the TPS elastomer and of the PPE is measured, in a known manner, by DSC (Differential Scanning calorimetry), for example and unless specifically indicated otherwise in the present application, according to the ASTM D3418 standard of 1999.

The number-average molecular weight (Mn) is determined, in a known manner, by size exclusion chromatography (SEC). The sample is firstly dissolved in tetrahydrofuran at a concentration of about 1 g/l and then the solution is filtered through a filter with a porosity of 0.45 μm before injection. The apparatus used is a WATERS Alliance chromatograph. The elution solvent is tetrahydrofuran, the flow rate is 0.7 ml/min, the temperature of the system is 35° C. and the analytical time is 90 min. A set of four Waters columns in series, with the “Styragel” tradenames (“HMW7”, “HMW6E” and two “HT6E”), is used. The injected volume of the solution of the polymer sample is 100 μl. The detector is a WATERS 2410 differential refractometer and its associated software, for handling the chromatograph data, is the WATERS MILLENIUM system. The calculated average molecular weights are relative to a calibration curve obtained with polystyrene standards.

Although the two constituents described above (unsaturated TPS and PPE) are sufficient by themselves to give the textile material of the composite of the invention very high properties of adhesion to an unsaturated rubber such as natural rubber, certain conventional additives such as colourant, filler, plasticizer, tackifier, antioxidant or other stabilizer, crosslinking or vulcanization system such as sulphur and accelerator, could optionally be added to the adhesive composition described previously.

In the present application the term “textile” or “textile material” is understood, by definition and in a manner well known to those skilled in the art, to mean any material made of a substance other than a metallic substance, whether it is natural or synthetic, which is capable of being transformed into a thread, fibre or film by any appropriate transformation process. Mention may for example be made, without the examples below being limiting, of a polymer spinning process, such as for example melt spinning, solution spinning or gel spinning

This textile material may consist of a thread or a fibre, a ribbon or film, or also of a fabric produced from threads or fibres, for example from a woven fabric with warp threads and weft threads, or else from a twill fabric with cross threads.

Preferably, this textile material is selected from the group consisting of films, monofilaments (or individual threads), multifilament fibres, assemblies of such threads or fibres and mixtures of such materials. It is more particularly a monofilament, a multifilament fibre or a folded yarn.

The term “thread” or “fibre” is generally understood to mean any elongate element of great length relative to its cross section, whatever the shape, for example circular, oblong, rectangular, square, or even flat, of this cross section, it being possible for this thread to be straight or not straight, for example twisted or wavy. The largest dimension of its cross section is preferably less than 5 mm, more preferably less than 3 mm.

This thread or fibre may take any known form. For example, it may be an individual monofilament of large diameter (for example and preferably equal to or greater than 50 μm), a multifilament fibre (consisting of a plurality of individual filaments of small diameter, typically less than 30 μm), a textile folded yarn or cord formed from several textile fibres or monofilaments twisted or cabled together, or else an assembly, group or row of threads or fibres such as for example a band or strip comprising several of these monofilaments, fibres, folded yarns or cords grouped together, for example aligned along a main direction, whether straight or not.

The term “film” or “ribbon” is generally understood to mean an elongate element of great length relative to its cross section, the cross section of which has an aspect ratio (width over thickness) of greater than 5, preferably greater than 10, and the width of which is preferably at least equal to 3 mm, more preferably at least equal to 5 mm.

Although materials made of a non-polymeric substance (for example made of a mineral substance such as glass or made of a non-polymeric organic substance such as carbon) are included in the definition of the textile material, the invention is preferably carried out with materials made of a polymeric substance, of both thermoplastic and non-thermoplastic type.

As examples of polymeric substances of non-thermoplastic type, mention will for example be made of aramid (aromatic polyamide) and natural and artificial cellulose, such as cotton or rayon.

As examples of polymeric substances of thermoplastic type, mention will preferably be made of aliphatic polyamides and polyesters. Among the aliphatic polyamides, mention may especially be made of the polyamides PA-4,6, PA-6, PA-6,6, PA-11 or PA-12. Among the polyesters, mention may be made, for example, of PET (polyethylene terephthalate), PEN (polyethylene naphthalate), PBT (polybutylene terephthalate), PBN (polybutylene naphthalate), PPT (polypropylene terephthalate) and PPN (polypropylene naphthalate).

In the case of a textile material made of a thermoplastic substance, the latter preferably has a Tg which is positive, more preferably above +20° C., more preferably still above +30° C. Moreover, the melting temperature (denoted by Tm) of this thermoplastic polymer is preferably above 100° C., more preferably above 150° C., in particular above 200° C.

The textile material of the composite of the invention may be prepared according to a sizing process, characterized in that it comprises at least one step of depositing, on the starting (initial) textile material, an adhesive composition or adhesive as described previously, which is solid or liquid depending on the case, it being possible for the two base constituents, namely unsaturated TPS elastomer and PPE, to be, for example, in the solid state, in the melt state or else in solution in a suitable organic solvent.

The step of depositing the adhesive composition onto the initial textile material (starting textile material) may be carried out according to any appropriate method, whether the targeted final adhesive layer consists of a thin coating or of a thick layer completely covering the textile material; the thickness of the adhesive layer could vary very widely depending on the particular production conditions of the invention.

The deposition of a thin coating, typically having a thickness within a range from 0.02 μm to 1 μm, could be carried out for example with an adhesive in the melt state (“hot” process) or advantageously in the liquid state (“cold” process requiring the use of an organic solvent), by any known coating technique such as for example spraying, impregnation by dipping, running through a bath or other equivalent technique for depositing a thin or ultra-thin adhesive film, or else by a combination of one or more of these techniques.

As a more particular example, the textile material, for example a folded yarn made of polyamide, passes, at a speed of a few m/min or tens of m/min and over a length of a few cm or tens of cm, into a bath filled with the mixture of PPE and epoxidized TPS elastomer, diluted (for example from 5% to 10% by weight) in toluene, or even simply between two wool felts pressed by a weight of 1 kg and continuously soaked with said liquid mixture, in order to thus cover the folded yarn with a thin or even ultra-thin adhesive layer.

The deposition of a thicker coating, typically having a thickness between 1 μm and 2 mm, could be carried out with an adhesive composition in the melt state (“hot” process not requiring the use of an organic solvent), preferably in this case by a technique of sheathing the starting textile material, advantageously by passing through an extrusion head. Such a sheathing step is carried out, in a manner known to those skilled in the art, continuously in line. For example, it simply consists in making the reinforcing thread pass through dies of suitable diameter in an extrusion head heated to an appropriate temperature.

As a more particular example, the textile material, for example a folded yarn made of polyamide, passes along an extrusion-sheathing line comprising two dies, a first die (counter-die or upstream die) and a downstream die, both dies being placed in an extrusion head. A mixture of epoxidized TPS and PPE, melted in the extruder, thus covers the folded yarn, on passing through the sheathing head, at a thread run speed typically equal to several tens of m/min for an extrusion pump rate typically of several tens of g/min. The mixing of the TPS and PPE may be carried out in situ, in the extrusion head itself, the two components then being introduced for example via two different feed hoppers; according to another possible exemplary embodiment, the TPS and PPE may also be used in the form of a previously manufactured mixture, for example in the form of granules, a single feed hopper then being sufficient. On exiting this sheathing die, the textile material thus coated may be immersed in a tank filled with cold water for cooling before the take-up reel is passed into an oven for drying.

In the case where an organic solvent is used, the overall content of the two base constituents (TPS plus PPE), in the adhesive in the liquid state, is preferably within a range from 1% to 20%, more preferably from 2% to 15%, for example in a range from 5% to 10% (% by weight of liquid adhesive). Any organic solvent capable of dissolving the TPS elastomer and the PPE can be used. Preferably, toluene is used.

According to one preferred embodiment, after the step described above of depositing the adhesive composition, and where necessary eliminating the organic solvent, a heat treatment step is carried out on the thus sized textile material, for example by passing through a tunnel oven, typically several metres in length, such as those commonly used for heat treatment after sizing textile materials with an RFL adhesive.

This heat treatment is more preferably carried out in air, in other words it is a thermal oxidation treatment. The treatment temperature is preferably between 150° C. and 350° C. The treatment times are from a few seconds to a few minutes depending on the case (for example between 10 s and 10 min), it being understood that the duration of the treatment will be shorter the higher the temperature and that the heat treatment necessarily must obviously not lead to the thermoplastic materials used remelting or even excessively softening.

Where appropriate, a person skilled in the art will know how to adjust the temperature and the duration of the heat treatment above according to the particular operating conditions of the invention, especially according to the exact nature of the textile material manufactured, in particular according to whether the treatment is on monofilaments, multifilament fibres, folded yarns consisting of several fibres twisted together, or films. In particular, a person skilled in the art will have the advantage of varying the treatment temperature and treatment time so as to find, by successive approximations, the operating conditions giving the best adhesion results for each particular embodiment of the invention.

After the heat treatment, the textile material according to the invention is advantageously cooled, for example in air, so as to avoid possible undesirable sticking problems while it is being wound onto the final take-up reel.

Thus sized and with the manufacture completed, the textile material can be used directly, that is to say without requiring any additional adhesive system, as a reinforcing element for an unsaturated rubber matrix such as a diene rubber matrix, in order to form a rubber composite reinforced with a textile material in accordance with the invention, such as for example a tyre. Its adhesive coating, crosslinkable with sulphur owing to the presence of the unsaturated TPS elastomer, is capable of ensuring the direct adhesive bonding of the textile material to an unsaturated rubber matrix in the uncured state.

The present invention applies to the case where the adhesive coating of the textile material is still in the liquid state (either in the melt state or in solution in an organic solvent), and to the case where this adhesive coating is in the solid state (either solidified or dried, i.e. stripped of the organic solvent, and where appropriate heat-treated).

The invention also applies to the cases where the starting textile material has been pre-dipped with an adhesion primer such as those commonly used by a person skilled in the art for pre-sizing certain textile fibres (e.g. PET or aramid fibres), before their subsequent and final sizing with a conventional RFL adhesive.

Preferably, in the textile material according to the invention that is ready to use, i.e. the manufacture of which is completed, the content of adhesive composition in the dry state represents between 2% and 20%, more preferably between 5% and 15% by weight relative to the starting (unsized) textile material.

The rubber composite of the invention may be prepared according to a process comprising at least the following steps:
during a first step, combining at least one portion of a starting textile material, its adhesive composition then being in the solid state, with a crosslinkable rubber composition, in order to form a rubber composite reinforced with the textile material;
then, during a second step, crosslinking the composite thus formed by curing, preferably under pressure.

The invention therefore applies to any type of rubber composite capable of being obtained by the process described above, comprising at least one matrix made of a diene or non-diene crosslinkable rubber composition, bonded to the textile material via an adhesive interphase based on the adhesive composition described above. The rubber of the composite of the invention is preferably a diene rubber.

A “diene” elastomer (or, without distinction, rubber) is understood, in a known manner, to mean an elastomer resulting at least in part (i.e. a homopolymer or a copolymer) from diene monomers, i.e. from monomers bearing two carbon-carbon double bonds which may or may not be conjugated. The diene elastomer used is preferably selected from the group consisting of polybutadienes (BR), natural rubber (NR), synthetic polyisoprenes (IR), butadiene-styrene copolymers (SBR), isoprene-butadiene copolymers (BIR), isoprene-styrene copolymers (SIR), butadiene-styrene-isoprene copolymers (SBIR) and mixtures of these elastomers. One preferred embodiment consists in using an “isoprene” elastomer, that is to say an isoprene homopolymer or copolymer, in other words a diene elastomer selected from the group consisting of natural rubber (NR), synthetic polyisoprenes (IR), various isoprene copolymers and mixtures of these elastomers. The isoprene elastomer is preferably natural rubber or a synthetic polyisoprene of cis-1,4 type.

Advantageously, the textile material according to the invention can be used to reinforce tyres for all types of vehicle, in particular for passenger vehicles or industrial vehicles such as heavy vehicles.

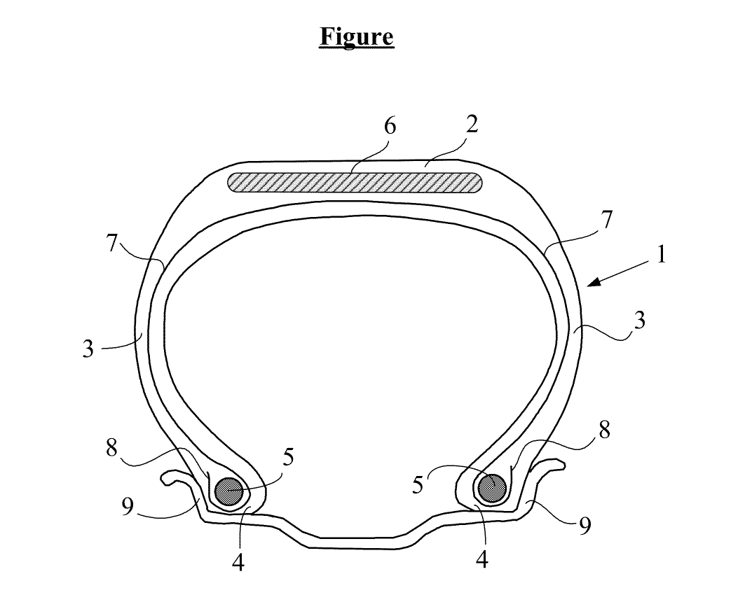

As an example, FIG. 1 appended hereto shows very schematically (without being drawn to a specific scale) a radial section through a tyre according to the invention for a passenger vehicle.

This tyre 1 comprises a crown 2 reinforced by a crown reinforcement or belt 6, two sidewalls 3 and two beads 4, each of these beads 4 being reinforced with a bead wire 5. The crown 2 is surmounted by a tread, not shown in this schematic figure. A carcass reinforcement 7 is wound around the two bead wires 5 in each bead 4, the upturn 8 of this reinforcement 7 lying for example towards the outside of the tyre 1, which here is shown fitted onto its rim 9. The carcass reinforcement 7 is, in a manner known per se, constituted of at least one ply reinforced with “radial”, for example textile, cords, that is to say that these cords are positioned practically parallel to one another and extend from one bead to the other so as to form an angle of between 80° and 90° with the median circumferential plane (plane perpendicular to the axis of rotation of the tyre which is located halfway between the two beads 4 and passes through the middle of the crown reinforcement 6).

This tyre 1 of the invention has for example the essential feature that at least a crown reinforcement (6) and/or its carcass reinforcement (7) comprises a rubber composite according to the invention. According to another possible embodiment example of the invention, it is, for example, the bead wires (5) and their beads (4) that could be made, completely or partly, from a composite according to the invention.

Of course, the invention relates to the objects described previously, namely the rubber composite and the tyre comprising it, both in the uncured state (before curing or vulcanization) and in the cured state (after curing).

### Exemplary Embodiments of the Invention

### Trial 1—Manufacture of a Textile Material and Composite According to the Invention

In this trial, the starting textile material was a textile folded yarn or cord made of polyamide 6,6 consisting of two strands in the form of a multifilament fibre each having a count or linear density of 140 tex (i.e. 140 g/m), the two strands being twisted together at 250 turns/metre in order to form what is customarily referred to as a folded yarn.

An adhesive was prepared from 7% by total weight of epoxidized SBS (“Epofriend AT501” from the company Daicel) plus PPE (“Xyron S202” from the company Asahi Kasei), and 93% by weight of toluene solvent, everything being subjected to stirring for 24 hours. The PPE/unsaturated TPS weight ratio was equal to around 0.4, the PPE content representing around one times the weight content of styrene in the SBS elastomer (i.e. 40% by weight of styrene in the SBS elastomer).

A step of sizing via coating was then carried out by passing the above textile reinforcer into a tank of adhesive under vacuum (suction), at a run speed of 5 m/min, under a tension of 500 g and without contact with any pulley. On exiting this impregnating bath, the textile cord thus impregnated passed through a device for evacuating the solvent that consisted of a 2 m long glass tube in which a counter-current of air under suction flowed, for drying.

Next the textile cord thus coated and dried underwent a final heat treatment, by passing into a tunnel oven, for around 50 s at a temperature of around 290° C. To determine the best operating conditions for the heat treatment in the above trial, a range of temperatures from 200° C. to 350° C., for four treatment times (10 s, 20 s, 50 s and 100 s), was examined beforehand.

A sized textile cord according to the invention was finally obtained, the content of adhesive coating (in the dry state) of which represented around 100 g per 1000 g of initial (unsized) textile material. This sized textile cord according to the invention is ready to use, i.e. is capable of adhering directly to a crosslinkable rubber composition such as a diene rubber composition, as explained in the following section.

### Trial 2—Adhesion Tests

The quality of the bond between the rubber and the textile cord manufactured above was then assessed by a test in which the force needed to extract lengths of textile cords, according or not according to the invention, from a vulcanized rubber composition, also called a vulcanizate, was measured. This rubber composition was a conventional composition used for the calendering of textile tyre carcass reinforcement plies, based on natural rubber, carbon black and standard additives.

The vulcanizate was a rubber block consisting of two sheets measuring 200 mm by 4.5 mm and with a thickness of 3.5 mm, applied against each other before curing (the thickness of the resulting block was then 7 mm). It was during the production of this block that the textile cords (15 lengths in total) were imprisoned between the two rubber sheets in the uncured state, an equal distance apart and with one end of each cord projecting on either side of these sheets an amount sufficient for the subsequent tensile test. The block containing the cords was then placed in a suitable mould and then cured under pressure. The curing temperature and the curing time, left to the discretion of a person skilled in the art, were adapted to the intended test conditions. For example, in the present case, the block was cured at 160° C. for 15 minutes under a pressure of 16 bar.

After being cured, the specimen, thus consisting of the vulcanized block and the 15 lengths of cords, was placed between the jaws of a suitable tensile testing machine so as to pull each length individually out of the rubber, at a given pull rate and a given temperature (for example, in the present case, at 50 mm/min and 20° C. or 100° C.). The adhesion levels were characterized by measuring the pull-out force (denoted by F.) for pulling the reinforcers out of the specimen (this being an average over 15 tensile tests).

It was observed that, in the composite of the invention (here consisting of the vulcanized block), the textile cord had a particularly high and unexpected pull-out force F., since it was increased by about 45% at 20° C. and by about 20% at 100° C., compared to the reference pull-out force measured on a control composite reinforced with a strictly identical textile cord but that was sized with a conventional RFL adhesive.

In conclusion, the rubber composite of the invention, owing to its textile material provided with a specific adhesive coating, constitutes a particularly useful alternative, on account of the very high levels of adhesion to the rubber that are obtained, to the composites of the prior art that are reinforced with textile materials sized in a known manner with an RFL adhesive.

1-23. (canceled)

24. A rubber composite comprising a reinforcement formed of a textile material,
wherein at least a portion of the textile material is coated with an adhesive layer, and
wherein the adhesive layer includes an adhesive composition based on at least a unsaturated thermoplastic styrene elastomer and a poly(p-phenylene ether).

25. The rubber composite according to claim 24, wherein a glass transition temperature of the unsaturated thermoplastic styrene elastomer is negative.

26. The rubber composite according to claim 24, wherein the unsaturated thermoplastic styrene elastomer is a copolymer that includes styrene blocks and diene blocks.

27. The rubber composite according to claim 25, wherein the unsaturated thermoplastic styrene elastomer is a copolymer that includes styrene blocks and diene blocks.

28. The rubber composite according to claim 26, wherein the diene blocks of the unsaturated thermoplastic styrene elastomer are isoprene or butadiene blocks.

29. The rubber composite according to claim 27, wherein the diene blocks of the unsaturated thermoplastic styrene elastomer are isoprene or butadiene blocks.

30. The rubber composite according to claim 24, wherein the unsaturated thermoplastic styrene elastomer includes a functional group selected from: an epoxide group, a carboxyl group, an acid anhydride group, and an ester group.

31. The rubber composite according to claim 30, wherein the unsaturated thermoplastic styrene elastomer is an SBS compolymer or an SIS copolymer.

32. The rubber composite according to claim 24, wherein the poly(p-phenylene ether) has a glass transition temperature above 150° C.

33. The rubber composite according to claim 24, wherein the poly(p-phenylene ether) is poly(2,6-dimethyl-1,4-phenylene ether).

34. The rubber composite according to claim 24, wherein the textile material is formed of a substance that includes a thermoplastic polymer.

35. The rubber composite according to claim 24, wherein the rubber composite is incorporated in a tyre.

36. A method for manufacturing a rubber composite reinforced with a textile material, the method comprising:
forming a rubber composite that is reinforced with a textile material by combining a textile material with a crosslinkable rubber, wherein at least a portion of the textile material is coated with an adhesive layer, and wherein the adhesive layer includes an adhesive composition based on at least a unsaturated thermoplastic styrene elastomer and a poly(p-phenylene ether), the adhesive composition being in a solid state; and
crosslinking the rubber composite by curing.
